(19) United States
(12) Patent Application Publication
(10) Pub. No.: US 2012/0114726 A1
(43) Pub. Date: May 10, 2012

(54) INSECTICIDE-COATED SUBSTRATE FOR PROTECTING HUMANS AND PETS

(75) Inventors: Hartmut Leininger, Neustadt (DE); Susanne Stutz, Weinheim (DE); Ulrich Karl, Grunstadt (DE)

(73) Assignee: BASF SE, Ludwigshafen (DE)

(21) Appl. No.: 13/382,694

(22) PCT Filed: Jul. 5, 2010
(86) PCT No.: PCT/EP2010/059523

§ 371 Date: Jan. 6, 2012

(30) Foreign Application Priority Data
Jul. 9, 2009 (EP) 09165019.2

(51) Int. Cl. A01N 43/36; A01N 25/08; A01P 7/04

(52) U.S. Cl. 424/411; 514/427; 424/409

(57) ABSTRACT

A substrate treated with a composition comprising a pyrethroid, chlorfenapyr and a special acrylate binder is suitable for controlling harmful insects in buildings, for protecting humans and domestic animals from such harmful insects and for protecting humans and domestic animals from vector-transmitted diseases which are transmitted by the harmful insects.

The invention relates to a substrate, in particular to a net, which has been coated with a pyrethroid-comprising active compound mixture for the protection of humans and domestic animals from harmful insects, in particular mosquitoes, and to the insecticidal compositions suitable for coating.

Means for controlling vector-transmitted diseases such as malaria, yellow fever, dengue fever, lymphatic filariosis and leishmaniosis which have proven particularly effective are insecticide-finished mosquito nets. For example, one of the columns of the global “Roll Back Malaria Partnership” project, besides spray applications of insecticides to internal walls of dwellings, is the use of such nets, which is recommended by the WHO (World Health Organization). In order to ensure efficient protection over a prolonged period of time, the nets must be finished in such a way that the insecticidal activity is not lost even after a substantial number of washes. Suitable nets which have been treated with specific insecticide/binder combinations are also referred to as LLINs (Long Lasting Insecticidal Nets).

Insecticides which are currently being used in this context are virtually exclusively pyrethroids since this class of insecticides not only has a high lethal effect on the insects combined with low mammalian toxicity, but the insect is also put out of action as the result of rapid paralysis before it can bite and thus transmit the disease (known as the knock-down effect).

However, the fact that pyrethroids have been used for many years and are increasingly being used also means that there is a risk of an increased onset of resistances, especially since these insecticides are also employed in agriculture for controlling crop pests. Thus, for example, pyrethroid resistance has arisen in Anopheles gambiae in West Africa and East Africa and in Anopheles funestus in Southern Africa.

The use of alternative insecticides, if appropriate as a mixture with pyrethroids, is being discussed for breaking and avoiding the development of resistances. One possible candidate in this context is chlorfenapyr, which has a good activity against anopheles mosquitoes, only a low degree of toxicity to humans and a mechanism of action different to that of pyrethroids (decoupling of oxidative phosphorylation in mitochondria, mitochondrial electron transport inhibitor, METI) (see, for example, R. N'Guessan et al., Acta Tropica 102 (2007) 69-78; F. W. Mosha et al., Tropical Medicine and International Health 13(5) 2008 644-652; R. N'Guessan et al., Tropical Medicine and International Health 14(4) (2009) 1-7). Combinations of chlorfenapyr and a pyrethroid are also proposed in the abovementioned documents.

In practice, however, it is extremely difficult to provide a system of two different active substances and a suitable binder, which system meets the requirements of controlled release combined with simultaneous high wash resistance for both insecticidal components. Thus, WO 2009/003468 (page 2, lines 9-15) finds that:

“When different insecticides are incorporated into a polymer matrix, [. . .] the migration of the insecticides can be difficult to control, as a migration promoter or inhibitor of one insecticide or synergist may influence the migration of the other insecticide. Thus, if a certain release is desired of different insecticides, this is a [sic!] difficult to achieve, though highly desired.”

The disclosed solutions for the use of insecticide combinations (or of combinations of insecticide and a synergist) therefore propose a spatially separate application, at least in part, of the different active substances.

WO 2008/098572 discloses a bilayer coating which comprises a first polymer matrix film into which a synergist is incorporated, to which film a second coating film with the incorporated insecticide is applied.

WO 2009/003468 describes an insecticidal thread which comprises two fibers which are impregnated with different insecticides/synergists. Alternatively, it may take the form of an extruded monofilament comprising different active substances/synergists on different sections.

WO 2009/003469 describes an insecticidal net construct comprising an insecticide and a synergist in spatially separate regions.

WO 2009/059607 describes a room comprising a first object, for example a mosquito net, which is coated with a first insecticide, and a second object, for example a back of a chair, which is impregnated with a second insecticide.

Oxborough et al., Annals of Tropical Medicine & Parasitology 102 (2008) 717-727 and P. Guillet et al., Medical and Veterinary Entomology 15 (2001) 105-112 describe insecticide combinations in which, in what is known as a 2-in-1 application, an insecticide other than pyrethroids is applied to the upper section of a mosquito net, while the side sections are treated with a pyrethroid.

As a rule, however, the abovementioned materials and devices are complicated to produce and to use, which is impractical, frequently also for economical reasons, and therefore still offer a great deal of room for improvement, in particular with regard to their efficacy.

It was therefore still an object to provide insecticide-impregnated nets, in particular durably insecticide-impregnated nets, which firstly are well suited to break pyrethroid resistances as the result of the combination of a pyrethroid with a further insecticide, but secondly are very simple to produce and to use while having a good insecticidal activity.

It has been found that certain substrates, in particular textile materials, preferably nets, which have been coated with a pyrethroid and chlorfenapyr in combination with a mixture of a certain acrylate binder, are particularly suitable for protecting humans or domestic animals from harmful insects.

WO 2008/052913 proposes, inter alia, a combination of α-cypermethrin and chlorfenapyr for impregnating nets intended for the protection of crop plants. However, the wash resistance requirements for such applications are moderate, and the document mentions nothing with regard to a combination of insecticide mixture and binder that might be suitable for a use for protecting humans and domestic animals from vector-transmitted diseases.

The invention therefore relates to a substrate

coated with a composition comprising
A) 0.1 to 45% by weight (based on the total of A plus B) of a mixture A, consisting of
   A1) 99 to 1% by weight (based on A) of one or more pyrethroids;
   A2) 1 to 99% by weight (based on A) of chlorfenapyr, and
B) 99.9 to 55% by weight (based on the total of A plus B) of an acrylate binder, obtainable by emulsion polymerization of
   B1) 20 to 93% by weight (based on B) of one or more (meth)acrylates of the formula (I)

H₂C═CR¹—COOR² (I)
where
R¹ is H or CH₃ and
R² is a linear or branched C₁-C₁₂-alkyl group;
B2) 1 to 5% by weight (based on B) of at least one monomer selected from the group consisting of N-methylolacrylamide, N-methylolmethacrylamide, N,N′-bismethylolmaleic diamide and N,N′-bismethylolfumaric diamide;
B3) 0.2 to 5% by weight (based on B) of at least one monomer selected from the group consisting of acrylic acid, methacrylic acid, vinylsulfonic acid, maleic acid and fumaric acid;
B4) 0 to 5% by weight (based on B) of at least one monomer selected from the groups
   B4A) monomers of the formula (II) and/or (III),

H₂C═CR³X (II)

ZHC═CHZ (III)
where the symbols have the following meanings:
R³ is H or CH_{3;}
X is Z, —CO—NH—CH₂—NH—CO—CR³═CH₂ or COO—CH₂—CO—CH₂—COOR⁴;
Z is CONH₂, CONH—CH₂—OR⁵, COO—Y—OH, CO-glycidyl, CHO or CO—Y—OH;
Y is C₁-C₈-alkylene and
R⁴, R⁵ are identical or different and are a linear or branched C₁-C₁₀-alkyl group;
B4B) allyl acrylate, methallyl acrylate, allyl methacrylate, methallyl methacrylate, diallyl maleate, dimethallyl maleate, allyl fumarate, methallyl fumarate, diallyl phthalate, dimethallyl phthalate, diallyl terephthalate, dimethallyl terephthalate, p-divinylbenzene and ethylene glycol diallyl ether;
B5) 0 to 40% by weight (based on B) of at least one monomer selected from the groups
   B5A) acrylonitrile, methacrylonitrile, maleonitrile and fumaronitrile and/or
   B5B) unpolar ethylenically unsaturated monomers other than B1-B4.

The invention furthermore relates to the use of the substrate according to the invention for protecting humans and domestic animals from harmful insects and from vector-transmitted diseases.

The invention likewise relates to methods of controlling harmful insects and of protecting humans and domestic animals from harmful insects and/or vector-transmitted diseases, in which methods a coated substrate according to the invention is applied in a building.

The invention furthermore relates to an aqueous formulation comprising the combination according to the invention of chlorfenapyr, a pyrethroid and the above-mentioned acrylate binder.

The substrates coated according to the invention are distinguished by simple production and, in particular in the form of nets, simple use. Nets coated according to the invention also have a good insecticidal activity, including a good insecticidal activity against pyrethroid-resistant harmful insects, even after repeated washing. The insecticide-coated substrates feature favorable toxicological data and permit an effective control of even pyrethroid-resistant harmful insects.

Insecticides

According to the invention, there is employed a mixture of chlorfenapyr and at least one pyrethroid.

Chlorfenapyr (V),

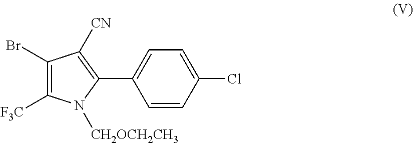

(IUPAC name: 4-Bromo-2-(4-chlorophenyl)-1-ethoxymethyl(5-trifluoromethylpyrrole-3-carbonitrile)) is commercially available from BASF SE and is described for example in: C. D. S. Tomlin (Ed.), The Pesticide Manual, 14th ed., British Crop Protection Council, Alton (UK) 2006.

Suitable as pyrethroid component are, for example, pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin; pyrethroid ether insecticides such as etofenprox, flufenprox, halfenprox, protrifenbute, silafluofen and natural pyrethroids such as pyrethrin I and II, cinerin I and II and jasmolin I and II.

Preferred are cypermethrin, alpha-cypermethrin, deltamethrin, permethrin, cyfluthrin, beta-cyfluthrin, cyhalothrin and lambda-cyhalothrin.

Especially preferred are alpha-cypermethrin, deltamethrin and permethrin.

Very especially preferred is alpha-cypermethrin.

Preferred is the use of a binary mixture of chlorfenapyr and a pyrethroid, but it is also possible to employ chlorfenapyr in a mixture with a plurality of, preferably two, pyrethroids.

Pyrethroids in general and the active compounds mentioned in particular are known and are commercially available; alpha-cypermethrin, for example, are commercially available from BASF SE, Ludwigshafen, Germany. The active compounds are described for example in The Pesticide Manual (see above). Further information is also found in H. Mehldorn (Ed.), Encyclopedic Reference of Parasitology, 2nd Ed., Disease Treatment, Therapy, 2001. Also, piperonyl butoxide is described in The Pesticide Manual (see above).

The mixing ratio chlorfenapyr:pyrethroid is, generally, 0.01-100:1, preferably 0.1-10:1, especially preferably 0.1-5:1, in particular 0.5-2:1.

The concentration of the insecticide mixture (chlorfenapyr and pyrethroid) in the preferably aqueous formulation which serves for coating the substrate (see hereinbelow) is adjusted such that the desired insecticide concentration on the net results, the liquid uptake of the substrate being known. In general, the amount of the insecticide mixture in the aqueous formulation is from 0.05 to 1% by weight, preferably from 0.1 to 0.7% by weight (based on the aqueous formulation).

The particle size of the insecticides in the aqueous formulation is generally from 50 nm to 20 μm, preferably 50 nm to 8 μm, especially preferably 50 nm to 4 μm, in particular 50 nm to 500 nm.

Acrylate Binder (B)

The function of the binder is to fix the active compound combination on the textile material. The result achieved hereby is that the active compounds will not be leached, or at least only very slowly, with repeated washing.

The acrylate binder employed according to the invention is a copolymer which can be obtained by emulsion polymerization of the components B1 to B4, and optionally B5.

As component B1, one or more, preferably 1, 2 or 3, especially preferably 1, (meth)acrylate(s) of the formula (I)

H₂C═CR¹—COOR² (I)

is/are employed, where the symbols have the following meanings:
R¹ is H or CH₃, preferably H, and
R² is C₁-C₁₀-alkyl, preferably methyl, ethyl, n-propyl, i-propyl, n-butyl, i-butyl, sec-butyl, t-butyl, n-pentyl, sec-pentyl, neopentyl, 1,2-dimethylpropyl, i-amyl, n-hexyl, i-hexyl, n-heptyl, n-octyl, 2-ethylhexyl, n-nonyl or n-decyl, especially preferably methyl, ethyl, n-butyl or 2-ethylhexyl, very especially preferred are ethyl, n-butyl or 2-ethylhexyl.

Preferred as component B1 are methyl acrylate, ethyl acrylate, n-butyl acrylate, 2-ethylhexyl acrylate and methyl methacrylate. Also preferred are butyl acrylate on its own or in admixture with methyl methacrylate or ethyl acrylate. Especially preferred is n-butyl acrylate.

Substances which are employed as component B2 are at least one monomer from the group consisting of N-methylolacrylamide, N-methylolmethacrylamide, N,N′-bismethylolmaleic diamide and N,N′-bismethylolfumaric diamide.

Preferred are N-methylolacrylamide and N-methylolmethacrylamide, in particular N-methylolmethacrylamide.

Substances which are employed as component B3 are one or more monomers, preferably one or two monomers selected from the group consisting of acrylic acid, methacrylic acid, vinylsulfonic acid, maleic acid and fumaric acid. Preferred are acrylic acid and methacrylic acid; acrylic acid is especially preferred.

Substances which are employed as component B4 are one or more monomers, preferably one or two monomers, selected from groups B4A and/or B4B.

Monomers of group B4A are those of the formula (II) and/or (III)

H₂C═CR³X (II)

ZHC═CHZ (III)

where the symbols have the following meanings:
R³ is H or CH₃, preferably H;
X is Z, —CO—NH—CH₂—NH—CO—CR³═CH₂ or COO—CH₂—CO—CH₂—COOR⁴, preferably Z;
Z equals CONH₂, CONH—CH₂—OR⁵, COO—Y—OH, COO-glycidyl, CHO, CO—Y—OH, preferably CONH₂;
Y is C₁-C₈-alkylene, preferably C₂-C₆-alkylene, and
R⁴, R⁵ are identical or different and are a linear or branched C₁-C₁₀-alkyl group;
and (meth)acrylic-modified benzophenones, as described, for example, in EP-A 0 346 734.

Preferred as monomers from group B4A are acetoacetyl acrylate, acetoacetyl methacrylate, acrylamide, methacrylamide, maleic diamide, N-methoxymethylacrylamide, N-n-butoxymethylacrylamide, 3-hydroxypropyl acrylate, 3-hydroxypropyl methacrylate, 4-hydroxybutyl acrylate, 4-hydroxybutyl methacrylate, 6-hydroxyhexyl acrylate, 6-hydroxyhexyl methacrylate, 2-hydroxy-3-chloropropyl acrylate, 3-hydroxy-3-chloropropyl methacrylate, glycidyl acrylate and glycidyl methacrylate. Especially preferred are acrylamide, 3-hydyroxypropyl methacrylate, butanediol monoacrylate acetylacetate, glycidyl methacrylate, and 4-acryloxy-benzophenone.

Substances which are employed as monomers from group B4B are allyl acrylate, methallyl acrylate, allyl methacrylate, methallyl methacrylate, diallyl maleate, dimethylallyl maleate, allyl fumarate, methallyl fumarate, diallyl phthalate, dimethylallyl phthalate, diallyl terephthalate, dimethallyl terephthalate, p-divinylbenzene, butane-1,4-diol diallyl ether and butane-1,4-diol dimethylallyl ether.

Preferred monomers of group B4 are those of group B4A, the use of one or two monomers from among this group being preferred.

Preferred monomers of group B5 are those of group B5A, and also vinylaromatic monomers of group B5B.

It is preferred to employ acrylonitrile or methacrylonitrile, preferably acrylonitrile, as component B5A.

Preferred as component B5B are styrene and α-methylstyrene, styrene being especially preferred.

In a preferred embodiment, acrylonitrile is employed as monomer of component B5 for the preparation of the acrylate binder.

The acrylate binder (B) is obtainable by emulsion polymerization of (data in % by weight are in each case based on the total amount of B):
b1) 20 to 93% by weight, preferably 50 to 90% by weight, especially preferably 60 to 90% by weight, in particular 75 to 85% by weight, of component B1;
b2) 1 to 5% by weight, preferably 1.5 to 3% by weight of component B2;
b3) 0.2 to 5% by weight, preferably 0.5 to 4% by weight, especially preferably 0.75 to 4% by weight, in particular 1 to 3% by weight of component B3;
b4) 0 to 7% by weight, preferably 0 to 5% by weight, especially preferably 0 to 4.5% by weight, in particular 0 or 0.2 to 4.5% by weight of component B4 and
b5) 0 to 40% by weight, preferably 5 to 40% by weight, especially preferably 5 to 30% by weight, in particular 0 or 5 to 26% by weight of component B5.

Suitable processes are known to the skilled worker and described, for example, in WO 2005/064072 (page 20, line 20 to page 23, line 15).

The weight-average molecular weight of the non-crosslinked emulsion polymers obtained is generally between 40 000 and 250 000 (as determined by GPC (gel permeation chromatography)). The molecular weight is generally adjusted by using chain termination reagents, for example organosulfur compounds, in the usual amounts.

The acrylate binder employed according to the invention is generally obtained in the form of an aqueous dispersion and is usually employed in this form in the insecticidal formulation according to the invention.

The acrylate binder according to the invention can furthermore comprise usual additives known to the skilled worker, for example film formers and/or plasticizers, such as adipates, phthalates, butyl diglycol, mixtures of diesters, obtainable by reacting dicarboxylic acids with straight-chain or branched alcohols. Suitable dicarboxylic acids and alcohols are known to the skilled worker.

Formulation for Impregnation—Crosslinker

To prepare the substrates according to the invention, in particular nets, the binders may be employed in the form of a formulation in a solvent, preferably as an aqueous formulation. However, the invention also comprises the use of solvent-free formulations.

In a preferred embodiment, aqueous formulations are employed which comprise 55 to 99% by weight of water, preferably 85 to 98% by weight of water and 0.5 to 45% by weight, preferably 1 to 10% by weight, of solids, the quantities given being in each case based on the total of all components in the formulation. The precise concentration also depends on the adsorptivity of the textile material.

The solids take the form of the acrylate binder, the insecticide mixture, optionally at least one crosslinker and optionally further components.

It is preferred to employ at least one water-dispersible crosslinker. This may in particular take the form of a crosslinker which has free isocyanate groups. These preferably take the form of isocyanurates which have free isocyanate groups, preferably isocyanurates which are derived from aliphatic, cycloaliphatic or aromatic diisocyanates having 4 to 12 carbon atoms. Examples comprise 1,6-hexamethylene diisocyanate (HMDI), 1,12-dodecane diisocyanate, 2,2′- and 2,4′-dicyclohexylmethane diisocyanate, 2,6 and/or 2,4-tolyl diisocyanate, 2-ethyltetramethylene diisocyanate, 2-methylpentamethylene diisocyanate, tetramethylene 1,4-diisocyanate, lysin ester diisocyanate (CDI), cyclohexane 1,3- and/or 1,4-diisocyanate, 1-isocyanato-3,3,5-trimethyl-5-isocyanatomethylcyclohexane (IPDI), 4,4′-, 2,4′- and/or 2,2′-diphenylmethanediisocyanate (monomeric MDI), polyphenyl polymethylene polyisocyanate (polymeric MDI) or mixtures comprising at least two of the abovementioned isocyanates. Preferred are isocyanurates based on 1,6-hexamethylene diisocyanate. Especially preferred are isocyanurates which have additional hydrophilic groups such as, in particular, polyethylene oxide groups. Very especially preferred are isocyanates which have been hydrophilicized with a polyalkylene oxide based on ethylene oxide and/or 1,2-propylene oxide, preferably ethylene oxide.

The isocyanurates employed as crosslinkers according to the invention preferably comprise from 5 to 25% by weight, especially preferably from 7 to 20% by weight, in particular from 10 to 15% by weight, of free isocyanate groups (based on the amount of isocyanate which has been employed as starting materials for preparing the isocyanurates).

The preparation of such isocyanurates is known to the skilled worker. They are preferably employed as a solution in polar aprotic solvents such as ethylene carbonate or propylene carbonate. Further details on the preferred crosslinkers having isocyanate groups are disclosed in WO 2008/052913 page 34, line 6 to page 35, line 3. It is especially preferred to employ an isocyanurate which is based on 1,6-hexamethylene diisocyanate (HMDI) and which has additional polyethylene oxide groups, the isocyanurate being dissolved in propylene carbonate (70% by weight of HMDI in propylene carbonate). The free isocyanate groups amount to approximately 11 to 12% by weight based on the solution. The crosslinker is preferably employed in an amount of from 1 to 10% by weight based on the amount of all solids of the formulation.

The formulation may furthermore comprise typical additives and adjuvants, UV stabilizers, defoamers and colorants. Examples of such additives are mentioned in WO 2006/128870 page 41, line 38 to page 43, line 22.

Besides serving purely esthetic purposes, colorants and pigments may have a warning effect for example on birds or mammals, or may bring about a camouflage effect of the insecticidal textile material against insects. Moreover, dark colors may bring about shading, which may be desired, and may reduce the harmful effect of UV light on active compounds and textile fibers when used in the open.

Crosslinkers and thickeners may be employed to enable uniform coating with the treatment liquor of substrates which can only be wetted with difficulty, and therefore inhomogeneously, such as, for example, polyolefin fibers. For this purpose, it would also be possible to employ water-miscible solvents, which, however, is not preferred due to the possible harmful effect on the environment. A person skilled in the art is familiar with the adjuvants which are conventionally used and with their concentrations.

The formulations may preferably comprise antioxidants, peroxide scavengers, UV absorbers and light stabilizers. This is particularly recommended in the case of nets which are exposed to increased UV irradiation in the open. The abovementioned additives protect not only the substrate fibers, but also the active compounds, from decomposition due to radiation.

Suitable UV absorbers are described for example in WO 02/46503 or in WO 2007/077101. UV absorbers may firstly be used as a component in the formulation for finishing; secondly, they may also be incorporated as early as during the production of the fibers, for example in the case of polyolefins and polyesters. It is also possible advantageously to employ mixtures of a plurality of stabilizers which have different protective effects. As a rule, from 0.2 to 5% by weight, preferably from 0.25 to 4% and very especially preferably from 0.5 to 3.5% by weight of stabilizer is employed based on the weight of the untreated textile material. The amount in the formulation will be adjusted by the skilled worker to suit the task in hand.

Coating Method

To prepare the coated substrate according to the invention, the untreated material is treated with a mixture comprising at least the acrylate binder and the insecticide mixture, preferably with the abovementioned aqueous formulation. The treatment can be carried out by processes known to the skilled worker, for example by immersing or spraying the untreated substrate with the formulation. The treatment can be carried out at room temperature or else at elevated temperatures. If crosslinking is to be carried out, the treatment step at lower temperatures, for example at from 10 to 70° C., may be followed by an aftertreatment at elevated temperatures, for example from 50 to 170° C., preferably from 70 to 150° C. Details of such a treatment are disclosed for example in WO 2005/064072, page 29, line 16 to page 35, line 36.

Coating can be effected by means of customary treatment apparatuses known to the skilled worker. Coating may also be carried out by the end user himself, using simple means, for example by dipping followed by drying in the air. To this end, it is preferred to choose a suitable binder system which does not require curing at elevated temperatures.

Substrate

Examples of suitable substrates are textile materials, nontextile plastic materials, paper, leather, man-made leather, films and other, preferably flexible, materials.

The substrate employed preferably takes the form of a textile material, in particular of nets made of textile fibers. They can take the form of nets made of natural fibers or synthetic fibers. Of course, they can also take the form of mixtures of two or more different fibers. Examples of natural fibers comprise cotton fibers, jute fibers or linen fibers. Preferably, they take the form of synthetic fibers made of suitable polymers. Examples comprise polyamides, polyesters, polyacrylonitrile or polyolefins. Preferably, they take the form of polyamides, polyolefins and polyesters, especially preferably polyolefins, in particular polypropylene or polyethylene, and polyesters, and very especially preferred are polyester fibers, in particular polyethylene terephthalate (PET).

The fibers may be smooth or textured. The fibers may take the form of monofilaments, oligofilaments or multifilaments.

Polypropylene and polyethylene may take the form of polypropylene or polyethylene homopolymers. However, they may also take the form of copolymers, which comprise small amounts of other comonomers in addition to the ethylene or propylene. Suitable comonomers may take the form of, in particular, other olefins such as, for example, ethylene or propylene and but-1-ene, but-2-ene, isobutene, pent-1-ene, hex-1-ene, hept-1-ene, oct-1-ene, styrene or α-methylstyrene, dienes and/or polyenes. In general, the comonomers in the polyethylene or polypropylene amount to no more than 20% by weight, preferably no more than 10% by weight. The nature and amount of the comonomers are selected by the skilled worker as a function of the desired fiber properties.

Products which are especially preferred for the production of fibers are relatively high-molecular-weight, viscous products which are characterized in the customary manner by their melt flow index (determined as specified in ISO 1133). Preferably, they may take the form of at least one polypropylene or polyethylene with a melt flow index MFR (230° C., 2.16 kg) of from 0.1 to 60 g/10 min. Preferably, they take the form of polypropylene with a melt flow index MFR (230° C., 2.16 kg) of from 1 to 50 g/10 min, especially preferably from 10 to 45 g/10 min and for example 30 to 40 g/10 min. Such types of polypropylene are particularly suitable for the production of fibers. Of course, a mixture of a plurality of different types of polypropylene may also be employed.

Depending on the nature of the net, the textile fibers have a thickness of from 0.05 to 0.6 mm, preferably 0.1 mm to 0.4 mm, especially preferably 0.12 to 0.35 mm and very especially preferably 0.2 to 0.3 mm.

The textile material is employed for example in the form of coverings or covers, for example for bed covers, mattresses, pillows, curtains, wall coverings, carpets, curtains for windows, cupboards and doors, ceilings, tarpaulins and tent cloths. Preferred are nets, in particular mosquito nets, for example bed nets for the protection against mosquitoes and other harmful insects.

The preferred nets which are employed preferably have a mesh pattern with an even number of corners. In this context, the nets may consist preferably of a simple type of mesh only, for example of quadrangular meshes only or of hexagonal meshes only, or else they may also comprise two or more types of different meshes, for example a combination of octagonal and quadrangular meshes.

In this context, the meshes of the net should preferably be essentially of the same type, i.e. while the net may indeed feature minor deviations in respect of shape and size of the meshes, the values will not vary unduly around the means.

Suitable mesh sizes (length of the side of a square mesh) are in the range of 5 mm, preferably 2.5 mm, in particular 1.5 mm as the upper limit and 0.1 mm, preferably 0.25 mm, especially preferably 0.5 mm, in particular 0.7 mm as the lower limit.

The meshes of the net are preferably selected from the group of quadrangular, hexagonal or octagonal meshes.

The quadrangular meshes take the form of meshes in the shape of a parallelogram with the sides a and b. Naturally, the term “parallelogram” also comprises the terms “rectangle” and “square”. The smaller angle between the two sides of the parallelogram will, as a rule, be between 60 and 90°. In the borderline case of 90°, the parallelogram takes the form of a rectangle. In the borderline case a=b and 90°, it takes the form of a square. The parallelogram furthermore has a height hₐ. In the case of a rectangle or a square, the height hₐ corresponds to the length of side a. Square meshes are particularly preferred.

In the case of the hexagonal meshes, three pairs of sides a, b and c, which run in each case parallel to each other, are arranged at the distances hₐ, h_{b} and h_{c}. In the case of the octagonal meshes, four pairs of sides a, b, c and d, which run in each case parallel to each other, are arranged at the distances hₐ, h_{b}, h_{c} and h_{d}. A person skilled in the art knows that no continuous patterns can be established with octagons. A net which comprises octagonal meshes will, therefore, additionally comprise at least one second type of mesh. These may take the form of quadrangular meshes.

In a specific embodiment of the invention, the height hₐ in the parallelogram, the hexagon and the octagon is from 0.1 to 0.99 mm, preferably from 0.1 to 0.9 mm, especially preferably from 0.12 to 0.8 mm and very especially preferably from 0.25 to 0.7 mm.

In the parallelogram, the length-to-height ratio b/hₐ is from 1:1 to 5:1, preferably from 1:1 to 4:1 and especially preferably from 2:1 to 4:1. Therefore, in the case of a ratio b/hₐ of 1:1, the meshes may take the form of a square with a side length of from 0.1 to 0.99 mm. In the case of a wider ratio of b/hₐ, they take the form of a structure which is elongated along one axis. By virtue of the distance hₐ of no more than 0.99 mm, even smaller insects are efficiently prevented from passing across the net, while the length can indeed be greater than 0.99 mm, so that the air permeability of the net is not unduly hindered.

In the case of a hexagon, the ratio ((h_{b}+h_{c}+h_{d})/2)/hₐ is from 1:1 to 5:1, preferably from 1:1 to 4:1 and especially preferably from 2:1 to 4:1. Here, the situation is analogous to the parallelogram. A ratio of 1:1 will result in a regular hexagon with three equal sides, each of which have an equal distance of no more than 0.99 mm to each other. A greater ratio ((h_{b}+h_{c}+h_{d})/2)/hₐ results in a hexagon which is elongated along one axis.

The effect regarding permeability to insects and air is as in the case of the parallelogram.

In the case of an octagon, the ratio ((h_{b}+h_{c}+h_{d})/3)/hₐ is from 1:1 to 5:1, preferably from 1:1 to 4:1 and especially preferably from 2:1 to 4:1. Here, the situation is analogous to the parallelogram. A ratio of 1:1 will result in a regular octagon with four equal sides, each of which have an equal distance of no more than 0.99 mm to each other. A greater ratio ((h_{b}+h_{c}+h_{d})/3)/hₐ results in an octagon which is elongated along one axis. The effect regarding permeability to insects and air is as in the case of the parallelogram.

Besides quadrangular and hexagonal meshes, it is also possible, for example, to employ combinations of quadrangular and octagonal meshes in this embodiment, or to vary the shape and size of the meshes in parts of the net. For example, the edges of the net can be knitted more densely, or else thicker textile fibers, which are also made of a different polymer, may be knitted in at certain distances in order to stabilize the net.

The terms “height” and “length” refer to the open area of each mesh without taking into consideration the fibers or the coated fibers. Analogously, the term “mesh size” for the purposes of the present invention means the hole size of the meshes, i.e. the open area of each mesh without taking into consideration the fibers or the coated fibers.

Textile net materials according to this embodiment of the invention are described in European Patent Application 08161456.2.

The thickness of the fibers used for the production of the textile material according to the invention, in particular of the nets according to the invention, is selected by the skilled worker depending on the desired properties of the net. As a rule, the thicker the fibers, the greater the mechanical stability of the net; on the other hand, the proportion of open area in comparison with the proportion of the fiber-covered area will decrease with decreasing mesh size. As a rule, the fiber thickness should be such that the open area of the net will be at least 20%, preferably at least 40% and in particular at least 50% of the net. Nets of the abovementioned type are commercially available.

The nets used can preferably take the form of single-layer nets. However, they may also take the form of what are known as spacer fabrics, where two nets are connected to one another with the aid of individual yarns to form a double layer.

Properties and Use of the Substrates According to the Invention

Substrates according to the invention, in particular nets, are suitable for protecting humans and domestic animals from harmful insects and from vector-transmitted diseases which are transmitted by the harmful insects.

Substrates according to the invention are also suitable for controlling harmful insects, wherein the substrate according to the invention, preferably in the form of a net, is applied in a building. In a preferred embodiment of the method according to the invention, a flexible substrate according to the invention, in particular a net, is applied around a live being or a nonlive object which, being a potential source of food, attracts the harmful insects.

The term harmful insects comprises according to the invention not only insects per se, but also harmful arachnids (Arachnida), in particular those which, being vectors, are responsible for transmitting diseases.

The substrates according to the invention are suitable in particular for protecting against, or controlling, hygiene pests and stored-product pests from the orders Diptera, Siphonaptera, Blattaria, (Blattodea), Dermaptera, Hemiptera, Hymenoptera, Orthoptera, Isoptera, Thysanura, Phthiaraptera, Araneida and Acarina, and the classes Chilopoda and Diplopoda. They are preferably suitable against Diptera, Hemiptera, Hymenoptera, Acarina and Siphonaptera.

In particular, they are suitable against Diptera, such as Culicidae, Simuliidae, Ceratopogonidae, Tabanidae, Muscidae, Calliphoridae, Oestridae, Sarcophagidae, Hippoboscidae, Siphonaptera (Pulicidae, Rhopalopsyllidae, Ceratophyllidae) and Acarina (Ixodidae, Argasidae, Nuttalliellidae), in particular against mosquitoes and flies.

In particular, the substrates according to the invention are suitable against:

Centipedes (Chilopoda), for example Scutigera coleoptrata,

Millipedes (Diplopoda), for example Narceus spp.,

Spiders (Araneae), for example Latrodectus mactans and Loxosceles reclusa,

Mites (Acaridida), for example Sarcoptes sp.

Parasitic mites (Parasitiformes): ticks (Ixodida), for example Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and Mesostigmata, for example Ornithonyssus bacoti and Dermanyssus gallinae,

Termites (Isoptera), for example Calotermes flavicollis, Leucotermes flavipes, Heterotermes aureus, Reticulitermes flavipes, Reticulitermes virginicus, Reticulitermes lucifugus, Termes natalensis and Coptotermes formosanus,

Cockroaches (Blattaria-Blattodea), for example Blattella germanica, Blattella asahinae, Periplaneta americana, Periplaneta japonica, Periplaneta brunnea, Periplaneta fuligginosa, Periplaneta australasiae and Blatta orientalis,

Dipterans (Diptera), such as flies and midges, for example Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culiseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola and Tabanus similis,

Earwigs (Dermaptera), for example Forficula auricularia,

Hemipterans (Hemiptera), such as lice and bugs, for example Cimex lectularius, Cimex hemipterus, Reduvius senilis, Triatoma spp., Rhodnius prolixus and Arilus critatus,

Hymenopterans (Hymenoptera), such as ants, bees, wasps and plant wasps, for example Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus and Linepithema humile,

Orthopterans (Orthoptera), such as crickets, grasshoppers and locusts, for example Acheta domestica, Gryllotalpa gryllotalpa, Locusta migratoria, Melanoplus bivittalus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera and Locustana pardalina,

Fleas (Siphonaptera), for example Ctenocephalides felis, Ctenocephalides canis, Xenopsylla cheopis, Pulex irritans, Tunga penetrans and Nosopsyllus fasciatus,

Bristletails (Thysanura), such as silverfish and firebrats, for example Lepisma saccharin and Thermobia domestica,

Lice (Phthiraptera), for example Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus.

The substrate according to the invention is especially preferably suitable for protecting against, or controlling, mosquitoes (Culicidae), in particular of the genera Anopheles, such as Anopheles gambiae, Anopheles stephensi, Anopheles funestus, Anopheles maculipennis, Anopheles claviger and Anopheles plumbeus; Aedes, such as Aedes aegypti (Stegomyia aegypti), Aedes albopictus; Culex, such as Culex quinquefasciatus; Culiseta; Haemagoggus; Mansonia; Ochlerotatus; Psorophora; Sabethes; Toxorhynchites; Verralina; Wyeomyia and Zeugnomyia.

The substrates according to the invention are furthermore preferably suitable for protecting against, or controlling, Siphonaptera (fleas), in particular Tunga (sand fleas), such as Tunga penetrans.

Substrates according to the invention, in particular nets, are especially preferably suitable for controlling harmful insects which display resistance either to pyrethroids or to chlorfenapyr, preferably pyrethroids.

Diseases whose transmission can be prevented are, besides diseases brought on by plasmodia, such as, for example, malaria tropicana, malaria tertiana and malaria quartana, also diseases which are brought on by parasitic worms, for example filariosis, disofilariosis, diseases brought on by viruses, for example yellow fever, dengue fever, Western Nile fever, Chikungunya fever, Rift Valley fever, diseases brought on by bacteria, for example tularemia and Chagas disease (South American trypanosomiasis), which is caused by the parasitic single-celled organism Trypanosoma cruzi and transmitted by predatory bugs.

In addition, the substrates according to the invention, in particular nets, are also suitable for protecting crops to be stored, that is to say harvested plants or plant parts, if appropriate also in processed form.

They can be employed for example by wrapping the goods to be protected in the nets. The goods to be protected may, for example, take the form of wood stacks, fruit, vegetables, cereals, cocoa beans, coffee beans or spices. The goods may furthermore take the form of bales. Examples comprise bales selected from the group consisting of tea, tobacco or cotton.

The invention is illustrated in greater detail by the examples without being limited thereby.

### EXAMPLES

A) Acrylate Binder

Preparation of the Polymer Dispersions

General Procedure

250 g of water and 3 g of styrene Saatlatex (33% by weight) with a mean particle size of 30 nm are heated to 85° C., whereupon 5% by weight of the feed 2 are added. After 10 min, the addition of feed 1 (see below) and the remainder of feed 2 starts.

Feed 2 comprises 30 g of sodium peroxydisulfate dissolved in 39.9 g of H₂O. The composition of feed 1 is shown in table 1. Feeds 1 and 2 are added in the course of 3 hours, followed by afterpolymerization for 0.5 hour.

TABLE 1
Composition of feed 1 in % by weight pphm (parts per hundred monomers)

| Monomer | | | | | | | | | | |
|---|---|---|---|---|---|---|---|---|---|---|
| composition | MMA | S | AN | EHA | BA | EA | MaMol | AMol | AM | AS |
| A 1 | | 16.6 | | 30.0 | 30.0 | 20.0 | | 3.0 | | 0.4 |
| A 2 | 25.7 | 5.0 | | 5.3 | 60.0 | | 3.5 | | | 0.5 |
| A 3 | | 14.7 | 11.0 | | 70.0 | | 3.5 | | 0.5 | 0.3 |
| A 4 | 30.0 | 13.0 | 8.0 | | 45.2 | | | 3.0 | 0.5 | 0.3 |
| A 5 | 20.0 | 20.0 | | 17.0 | 23.0 | 15.3 | 3.5 | | | 1.2 |
| A 6 | 26.0 | | 13.0 | | 57.0 | | 3.0 | | | 1.0 |
| A 7 | 15.0 | | 13.0 | | 68.0 | | 3.0 | | | 1.0 |
| A 8 | | | 16.0 | | 81.0 | | 2.0 | | | 1.0 |

The amount of the initiator sodium peroxydisulfate is 0.3 parts by weight, that of the emulsifier 0.4 parts by weight of Dowfax 2A1 (Dow) and 0.6 parts by weight of Lumiten IRA (BASF SE), based on 100 parts by weight of the monomer composition of table 1.

Abbreviations

MMA: Methyl methacrylate

S: Styrene

AN: Acrylonitrile

EA: Ethyl acrylate

EHA: 2-Ethylhexyl acrylate

BA: n-Butyl acrylate

Amol: N-Methylolacrylamide

MAMol: N-Methylolmethacrylamide

AS: Acrylic acid

AM: Acrylamide

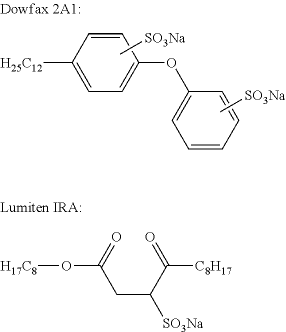

B) Production of the Nets Used:

TABLE 2

| | | Alpha- | | | | |
|---|---|---|---|---|---|---|
| | Alpha- | cypermethrin | | Chlorfenapyr | Acrylate | Acrylate binder |
| | cyper- | bath | Chlor- | bath | binder A8 | A8 bath |
| | methrin | concentration | fenapyr | concentration | weight on the | concentration |
| | [mg/m²] | [g/l] | [mg/m²] | [g/l] | net [%] | [g/l] |
| Net 1 | 100 | 3.2 | 0 | 0 | 0.55 | 5 |
| Net 2 | 100 | 3.2 | 100 | 3.2 | 1 | 10 |
| Net 3 | 0 | 0 | 100 | 3.2 | 0.55 | 5 |

Each of the nets employed for the experiments were finished with an aqueous formulation of the insecticide alpha-cypermethrin, the insecticide chlorfenapyr, the acrylate binder A8 and an isocyanate-based crosslinker, dried and crosslinked for 1 min at approximately 100° C. The amount of insecticide as shown in table 2 is adjusted by determining the liquid uptake of the net (if appropriate after squeezing under defined conditions), and the concentration of the formulation is adjusted so that the desired amount per square meter on the net results. The amount of binder was adapted to match the insecticide content.

C) Testing the Nets

The treated nets were washed repeatedly as shown in table 3. Washing was effected according to the procedure “Montpellier washing procedure” (as described in the appendix WHO PVC, 3/07/2002 “Evaluation of wash resistance of long-lasting insecticidal nets”). The procedure was carried out as specified in WO 2005/064072, page 46.

The samples were subjected to biological testing as specified in WO 2005/064072, page 47. This biological testing corresponds to the WHO “Cone Test” (WHOPES 96.1), with minor adaptations. The data determined were the “knock-down” after 60 minutes and the mortality after 24 hours.

The test organisms employed for the experiments were firstly an Aedes aegypti strain which was not resistant to pyrethroids and secondly a pyrethroid-resistant Anopheles gambiae strain.

TABLE 3

| | | Aedes | Aedes | Anopheles | Anopheles |
|---|---|---|---|---|---|
| | | aegypti | aegypti | gambiae | gambiae |
| | Washes | % KD | % Mortality | % KD | % Mortality |
| Net 1 | 0 | 100 | 100 | 20 | 40 |
| Net 1 | 20 | 98 | 96 | 15 | 38 |
| Net 2 | 0 | 98 | 95 | 96 | 90 |
| Net 2 | 20 | 100 | 100 | 100 | 85 |
| Net 3 | 0 | 100 | 92 | 90 | 85 |
| Net 3 | 20 | 98 | 98 | 85 | 80 |

The results demonstrate that nets according to the invention show a good effect, even against pyrethroid-resistant Anopheles mosquitoes.

1-15. (canceled)

16. A substrate, coated with a composition comprising
A) 0.1 to 45% by weight (based on the total of A plus B) of a mixture A, consisting of
A1) 99 to 1% by weight (based on A) of one or more pyrethroids;
A2) 1 to 99% by weight (based on A) of chlorfenapyr, and
B) 99.9 to 55% by weight (based on the total of A plus B) of an acrylate binder, obtainable by emulsion polymerization of
B1) 20 to 93% by weight (based on B) of one or more (meth)acrylates of the formula (I)
H₂C═CR¹—COOR² (I)
where
R¹ is H or CH₃ and
R² is a linear or branched C₁-C₁₂-alkyl group;
B2) 1 to 5% by weight (based on B) of at least one monomer selected from the group consisting of N-methylolacrylamide, N-methylolmethacrylamide, N,N′-bismethylol-maleic diamide and N,N′-bismethylolfumaric diamide;
B3) 0.2 to 5% by weight (based on B) of at least one monomer selected from the group consisting of acrylic acid, methacrylic acid, vinylsulfonic acid, maleic acid and fumaric acid;
B4) 0 to 5% by weight (based on B) of at least one monomer selected from the groups
B4A) monomers of the formula (II) and/or (III),
H₂C═CR³X (II)
ZHC═CHZ (III)
where the symbols have the following meanings:
R³ is H or CH₃,
X is Z, —CO—NH—CH₂—NH—CO—CR³═CH₂ or COO—CH₂—CO—CH₂—COOR⁴;
Z is CONH₂, CONH—CH₂—OR⁵, COO—Y—OH, CO-glycidyl, CHO or CO—Y—OH;
Y is C₁-C₈-alkylene and
R⁴ and R⁵ are identical or different and are a linear or branched C₁-C₁₀-alkyl group;
B4B) allyl acrylate, methallyl acrylate, allyl methacrylate, methallyl methacrylate, diallyl maleate, dimethallyl maleate, allyl fumarate, methallyl fumarate, diallyl phthalate, dimethallyl phthalate, diallyl terephthalate, dimethallyl terephthalate, p-divinylbenzene or ethylene glycol diallyl ether;
B5) 0 to 40% by weight (based on B) of at least one monomer selected from the groups
B5A)acrylonitrile, methacrylonitrile, maleonitrile or fumaronitrile and/or
B5B) unpolar ethylenically unsaturated monomers other than B1-B4.

17. The substrate according to claim 16, wherein component A1 of the composition is selected from the group consisting of cypermethrin, alpha-cypermethrin, deltamethrin, permethrin, cyfluthrin, beta-cyfluthrin, cyhalothrin and lambda-cyhalothrin.

18. The substrate according to claim 17, wherein component A1 is alpha-cypermethrin.

19. The substrate according to claim 16, wherein component B1 of the acrylate binder B is n-butyl acrylate.

20. The substrate according to claim 16, wherein component B2 of the acrylate binder B is N-methylolacrylamide or N-methylolmethacrylamide.

21. The substrate according to claim 16, wherein component B3 of the acrylate binder is acrylic acid.

22. The substrate according to claim 18, wherein
component B1 of the acrylate binder B is n-butyl acrylate,
component B2 of the acrylate binder B is N-methylolacrylamide or N-methylolmethacrylamide and
component B3 of the acrylate binder is acrylic acid.

23. The substrate according to claim 16 in the form of a textile material.

24. The substrate according to claim 16 in the form of a net.

25. An aqueous formulation for providing substrates with an insecticide coating comprising the composition according to claim 16.

26. The aqueous formulation according to claim 25, comprising a crosslinker which has free isocyanate groups.

27. A method of protecting humans and/or domestic animals from harmful insects which comprises applying the substrate according to claim 16 in a building which is used by the humans and/or the domestic animals.

28. A method of protecting humans and/or domestic animals from vector-transmitted diseases which are transmitted by harmful insects which comprises applying the substrate according to claim 16 is applied in a building which is used by the humans and/or the domestic animals.

29. A method of controlling harmful insects in a building which comprises applying the substrate according to claim 16 is applied in the building.

30. The method according to claim 27, wherein the harmful insects display a pyrethroid resistance.

31. The method according to claim 28, wherein the harmful insects display a pyrethroid resistance.

32. The method according to claim 29, wherein the harmful insects display a pyrethroid resistance.
